(19) United States
(12) Patent Application Publication
(10) Pub. No.: US 2008/0306685 A1
(43) Pub. Date: Dec. 11, 2008

(54) METHOD, SYSTEM AND COMPUTER PROGRAM FOR EXPLOITING IDLE TIMES OF A NAVIGATION SYSTEM

(76) Inventors: Gianluca Bernardini, Rome (IT); Alessandro Donatelli, Rome (IT); Rosario Gangemi, Rome (IT); Giovanni Lanfranchi, Placenza (IT)

Correspondence Address: IBM CORPORATION;INTELLECTUAL PROPERTY LAW, 11501 BURNET ROAD, AUSTIN, TX, 78758, US

(21) Appl. No.: 11/870,531

(22) Filed: Oct. 11, 2007

(30) Foreign Application Priority Data
Oct. 13, 2006 (EP) 06122228.7

(51) Int. Cl. G01C 21/00

(52) U.S. Cl. 701/211

(57) ABSTRACT

A solution is proposed for exploiting the resources of a navigation system. For this purpose, any idle time of the navigation system (during which no direction information is output) is used to provide descriptive information about the current location of the vehicle. For example, the navigation system estimates a timeframe available before approaching a next turn (following a current location of the vehicle along a route towards a desired destination). The navigation system presents predefined descriptive messages associated with the current location are then output in succession according to the available timeframe.

### FIELD OF THE INVENTION

The present invention relates to the information technology field. More specifically, the invention relates to navigation systems.

### BACKGROUND ART

Navigation systems have become increasingly popular in the last years. A navigation system consists of a small electronic device that aids a driver of a vehicle to reach a desired destination.

For this purpose, the navigation system monitors its current position (for example, by means of a GPS receiver); the navigation system also stores a map of an area of interest (with all its roads). In this way, the navigation system can determine a starting point of the vehicle (defined by its position at the selection of the destination); this allows calculating a suggested route (on the map) for reaching the destination from the starting point. The navigation system continuously detects a current location of the vehicle (defined by its position). Whenever the vehicle approaches a next turn along the route (following the current location towards the destination), the navigation system provides corresponding direction information to the user—for example, turn left or right.

Some navigation systems known in the art also store information about specific points of interest. In this case, the user can select a desired point of interest on the map, such as a hospital. The navigation system determines the location of the selected point of interest and then guides the user towards it in the same way as above.

The navigation system strongly facilitates the reaching of any desired destination. This is particularly useful when the user is traveling in a foreign environment, where s/he does not know how to find her/his way about. The advantages provided by the navigation system are still more evident when it is very difficult (if not impossible) to ask for directions (such as in freeways, large cities with heavy traffic, desert areas, or countries with an unknown language).

Nevertheless, the resources of the navigation system are typically under-exploited.

Indeed, the navigation system interacts with the user only when the vehicle approaches a next turn (for outputting the corresponding direction information); conversely, most of the time the navigation system remains mute, so as to appear idle to the user.

In any case, the navigation system is only capable of responding to explicit requests from the user (i.e., the selection of any destinations); on the contrary, the navigation system is completely unable to take any initiative of its own motion.

### SUMMARY OF THE INVENTION

The present invention provides a method, a system and a computer product for controlling a navigation system. The invention inputs an indication of a destination location. The current location of the navigation system is monitored. Direction information for reaching the destination location from the current location along a route selected on a predefined map is displayed. The display provides predefined descriptive information relating to the current location presented during at least part of an idle time when no direction information is output.

### REFERENCE TO THE DRAWINGS

The invention itself, as well as further features and the advantages thereof, will be best understood with reference to the following detailed description, given purely by way of a non-restrictive indication, to be read in conjunction with the accompanying drawings, in which:

FIG. 1 is a pictorial representation of a navigation system in which the solution according to an embodiment of the invention is applicable;

FIGS. 2a-2b illustrate exemplary applications of the solution according to an embodiment of the invention;

FIG. 3 is a collaboration diagram representing the roles of different software modules implementing the solution according to an embodiment of the invention;

FIG. 4 is a diagram describing the flow of activities relating to an implementation of the solution according to an embodiments the invention; and

FIG. 5 is an exemplary finite state machine that may be used to implement the solution according to an embodiment of the invention.

### DETAILED DESCRIPTION

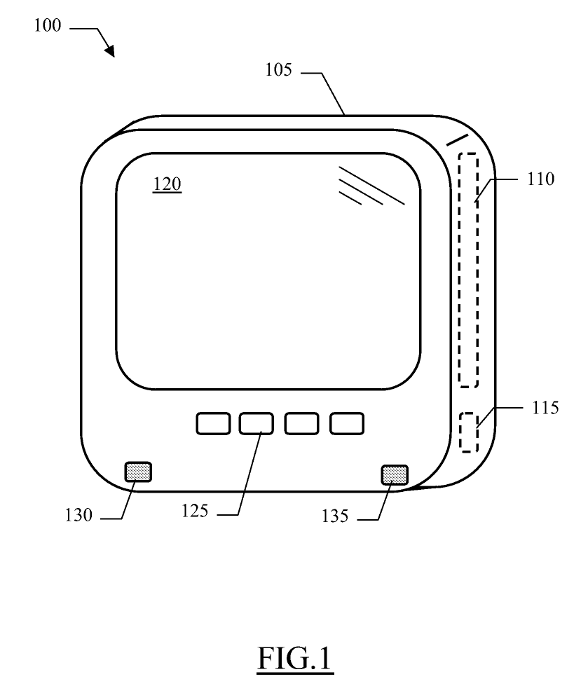

With reference in particular to FIG. 1, a navigation system 100 is illustrated. The navigation system 100 consists of a small electronic device, which is installed, on a vehicle—such as a car or a truck (not shown in the figure). As described in detail in the following, the navigation system 100 is used to aid a driver of the vehicle to reach any desired destination; for this purpose, the navigation system 100 monitors its position and provides corresponding directions to the user so as to guide him/her towards the destination.

The navigation system 100 has a main body 105, which houses electronic circuits 110 controlling its operations (such as a microprocessor, a working memory, a solid-state mass memory, drives for any input/output units, and the like). The navigation system 100 is also provided with a positioning receiver 115; typically, the positioning receiver 115 is based on the Global Positioning System (GPS) technology. The GPS technology exploits signals received from multiple satellites for determining the position of the navigation system 100 with an accuracy of a few tens of meters. Preferably, dead reckoning techniques (based on speed sensors and/or accelerometers) are used to improve the accuracy of the positioning receiver 115.

A user interacts with the navigation system 100 via a touch-screen 120. Typically, a few physical buttons 125 are also available on a front panel of the main body 105 (for example, reserved for shortcuts to specific functions). In addition, it is also possible, to provide a microphone 130 for entering vocal commands. Typically, the navigation system 100 outputs vocal messages by means of a loudspeaker 135.

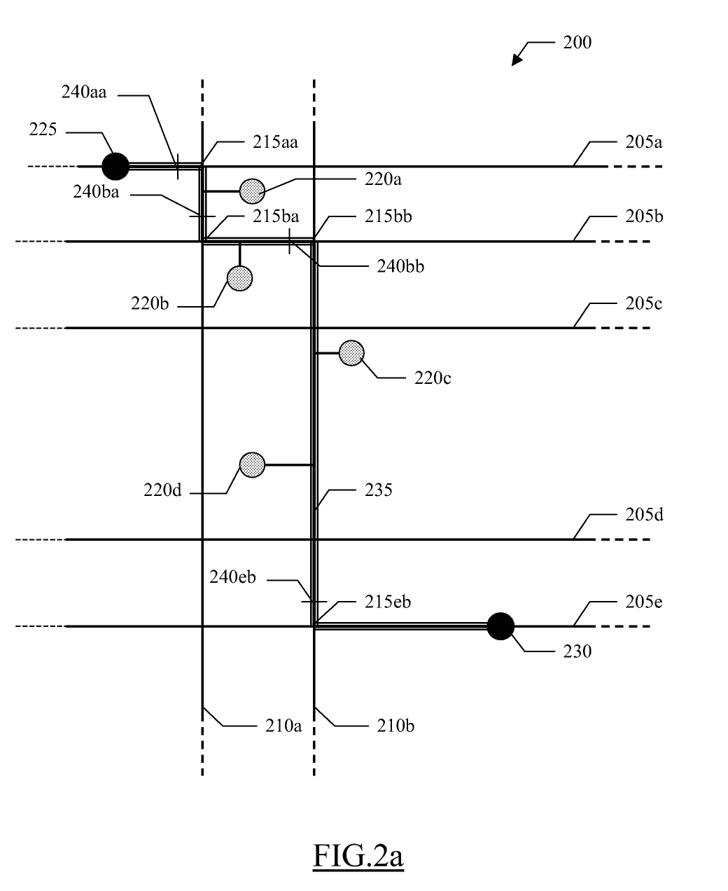

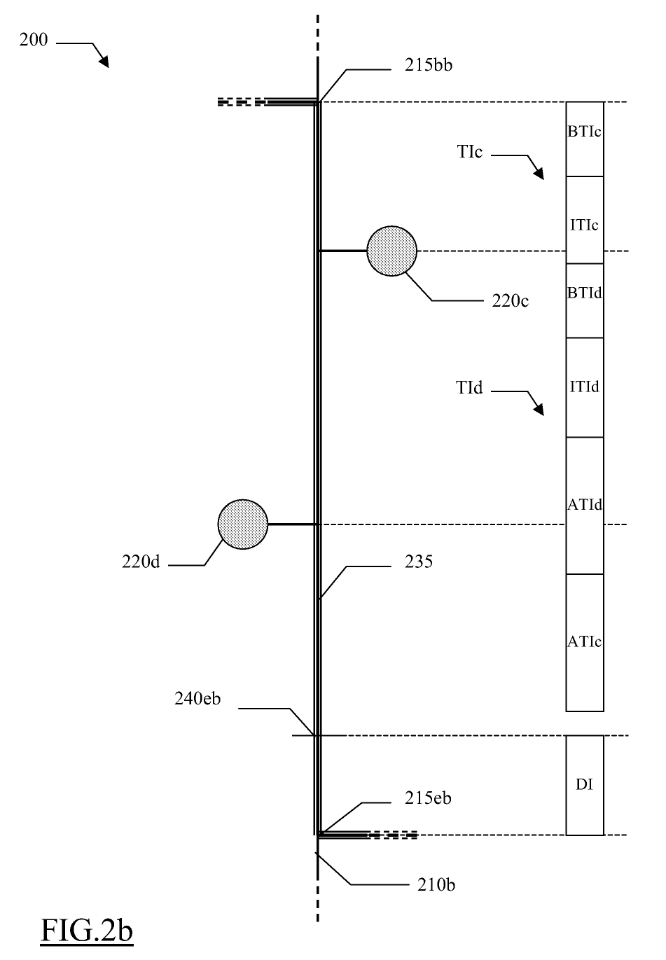

In operation, as shown in FIG. 2a, the navigation system is used to guide the user throughout a road infrastructure 200 of a region of interest. For this purpose, the navigation system stores a representation of this road infrastructure 200, which describes any roads of the region (consisting of practicable routes between different locations) with their junctions; in the example at issue, seven roads 205a-205e,210a-210b, with corresponding junctions 215xy (where x=a . . . e and y=a . . . b) are identified in the FIG. Typically, the navigation system also stores information about different Points of Interest (PoIs)—such as monuments, restaurants, hotels, gas stations, banks, post offices, hospitals, pharmacies, and the like; in the example at issue, four points of interest 220a-220d are illustrated (with corresponding roads without any reference).

At the beginning, the vehicle is at a starting point 225 (defined by the position of the navigation system in the road infrastructure 200). Let us assume now that the user wishes to reach the destination (in the road infrastructure) denoted with 230. The navigation system then calculates a suggested route 235 from the starting point 225 to the destination 230 (across the available roads of the infrastructure 200), as shown with a bold line in the figure.

The navigation system monitors a current location of the vehicle (defined by the position of the navigation system in the road infrastructure 200), so as to determine when the vehicle approaches every next turn along the route 235—following the current location towards the destination 230 (as defined by a corresponding junction 215xy). As soon as the vehicle reaches a warning location 240xy at a threshold distance from the next turn (such as 500 m), the navigation system provides corresponding direction information (such as turn left or right) to the user. In the specific scenario at issue, the navigation system will provide direction information when the vehicle reaches the warning location (denoted with 240aa) preceding the junction 215aa—between the road 205a and the road 210a; likewise, the navigation system will provide direction information when the vehicle reaches the warning location preceding the junction 215ba (denoted with 240ba), the warning location preceding the junction 215bb (denoted with 240bb), and the warning location preceding the junction 215eb (denoted with 240eb).

The solution according to an embodiment of the present invention is based on the observation that the navigation system is completely mute after every turn, until the next turn is approached (i.e., between the corresponding junction 215xy and warning location 240xy). Accordingly, this idle time of the navigation system is used to provide descriptive information relating to the current location of the vehicle (for example, consisting of descriptive information about the closest points of interest 220a-220d).

In this way, the resources of the navigation system are exploited at its best.

For example, it is possible to entertain the user while s/he moves in a foreign environment (and might be interested in having information about the places s/he crosses); the same technique may also be used to notify the user of any site that is encountered (and that might be worth a visit), or of any structure that might be of interest for the user (such as a shop).

These advantages are clearly perceived when it is very difficult (if not impossible) for the user to catch information about the surrounding environment (for example, when no descriptive sign is available). Moreover, the descriptive information can always be output in the native language of the user; this facilitates the understanding of the descriptive information (even when the user in traveling in a foreign country). In any case, the proposed solution prevents the user to wander for reading any descriptive signs; as a result, the risk of accidents is strongly reduced (with a beneficial impact on the road safety).

It is emphasized that the descriptive information that is provided to the user is unsolicited; indeed, this information is output automatically by the navigation system—among the direction information actually required for reaching the destination 230—without any intervention of the user.

Moving to FIG. 2b, there is illustrated an enlarged particular of the above-described road infrastructure 200 (consisting of the part of the road 210b between the junction 215bb and the junction 215eb).

As can be seen, after passing the junction 215bb the navigation system provides descriptive information (denoted with TIc) about the next point of interest 220c that will be encountered—following the current location of the vehicle (towards the destination) before the next turn of the junction 215eb. After passing the point of interest 220c, the navigation system then provides descriptive information (denoted with TId) about the new next point of interest 220d that will be encountered. In any case, as soon as the warning location 240eb is reached, the navigation system provides the (required) direction information for the next turn at the junction 215eb (denoted with DI).

In this way, the user is promptly informed of any point of interest just before reaching it (so as to allow him/her to make a detour for its possible visit).

Preferably, different predefined descriptive messages are associated with each point of interest. The descriptive messages provide information about the point of interest with different levels of detail, and then they have different lengths; each descriptive message adds value to the preceding descriptive messages (at lower levels of detail). For example, the point of interest may be associated with a basic descriptive message (Simply identifying the point of interest in a short time—such as a few seconds), an intermediate descriptive message (describing the main aspects of the point of interest in a longer time—such as some tens of seconds), and one or more advanced descriptive messages (going into specific aspects of the point of interest in a far longer time—up to some minutes).

In this case, the navigation system adapts the descriptive information that is output for each point of interest to the time that should be available for its outputting. For this purpose, the navigation system estimates a timeframe required to reach the next warning location from the current location—for example, according to their distance and a logged speed of the vehicle. The navigation system then outputs the descriptive messages in succession (in increasing order of level of detail, from the basic descriptive message to the last advanced descriptive message) until the residual timeframe allows their completion. For example, let us assume that the basic, descriptive, and advanced descriptive messages for the point of interest 220c have a length of 10 s, 30 s and 60 s, respectively, while the basic, descriptive, and advanced descriptive, messages for the point of interest 220d have a length of 20 s, 40 s and 70 s, respectively. After passing the junction 215bb, the timeframe for reaching the junction 215eb is estimated to be 500 s; in this condition, the point of interest 220c follows the current location. Therefore, the navigation system can output the basic descriptive message for the next point of interest 220c, denoted with ITIc (since 500 s>10 s); after that, the timeframe (for reaching the same junction 215eb from the hew current location) is re-estimated to be 480 s—for example, because the vehicle has moved faster than expected—so that the navigation system can output the intermediate descriptive message for the same point of interest 220c, denoted with ITIc (since 480 s>30 s). The vehicle passes the point of interest 220c, so that the new next one becomes the point of interest 220d. If the timeframe is now estimated to be 400 s the navigation system can output the basic descriptive message for the next point of interest 220d, denoted with BTId (since 400 s>20 s); likewise, the navigation system outputs the intermediate descriptive message, denoted with ITId (assuming a timeframe of 380 s>40 s) and the advanced descriptive message, denoted with ATId (assuming a timeframe of 300 s>70 s).

Preferably, in this condition (when all the descriptive messages for the next point of interest 220d have been output), the navigation system returns to complete the descriptive messages for the preceding point of interest 220c. In the example at issue, if the timeframe is estimated to be 200 s, the navigation system can output the advanced descriptive message for the preceding point of interest 220c, denoted with ATIc (since 200 s>60 s). This feature allows providing descriptive information for points of interest that have just been passed when no further descriptive information is available for the next ones (so as to avoid leaving the navigation system mute).

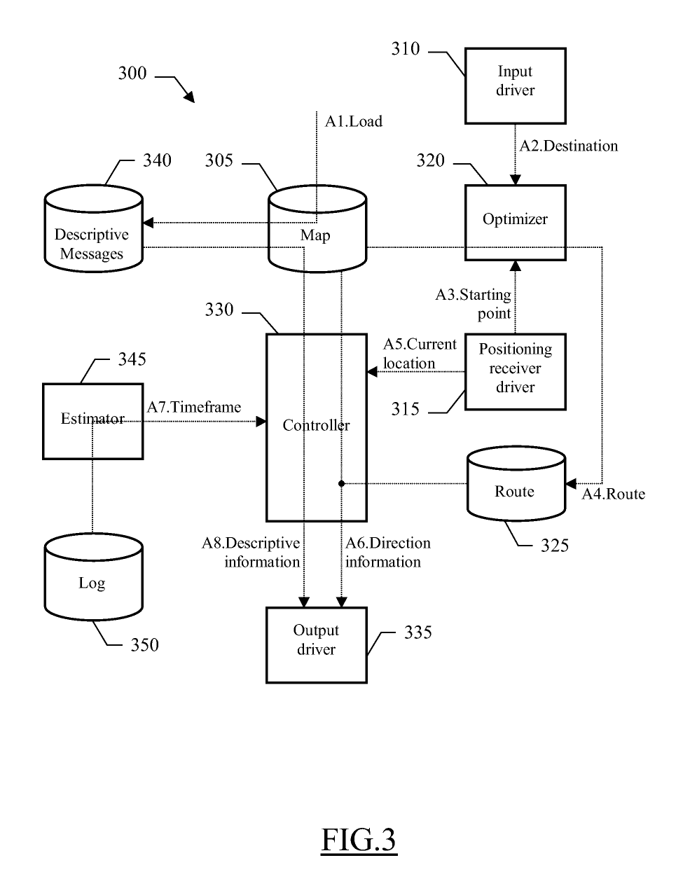

Moving to FIG. 3, the main software modules that run on the navigation system are denoted as a whole with the reference 300. The information (programs and data) is typically stored on the mass memory and loaded (at least partially) into the working memory of the navigation system when the programs are running. Particularly, the figure describes the static structure of the system (by means of the corresponding modules) and its dynamic behavior (by means of a series of exchanged messages, each one representing a corresponding action denoted with sequence numbers preceded by the symbol “A”).

The navigation system stores a map 305 of the region of interest; the map is loaded from an external source, such as a DVD or the Internet (action “A1.Load”). The map 305 provides a vector representation of the road infrastructure of the region; for this purpose, any relevant information is encoded by means of pair of geographic coordinates (latitude and longitude). Particularly, the map 305 stores the definition of all the roads of the region in the form of a graph—by means of the coordinates of every junction therebetween. The map 305 also includes the coordinates of any house number along the roads (for the identification of desired addresses). In addition, the map 305 stores the coordinates of all the relevant points of interest.

An input driver 310 is used to select the desired destination (action “A2.Destination”); for example, the user can point to a graphical representation of the destination on the touch-screen, or s/he can enter the corresponding address—i.e., road name and house number—vocally. The navigation system further includes a driver 315 for the positioning receiver. Whenever the user selects a new destination, the positioning receiver driver 315 records the coordinates of the starting point (action “A3.Starting point”).

An optimizer 320 receives the coordinates of the starting point (from the positioning receiver driver 315) and the coordinates of the destination (from the input driver 310). The optimizer 320 accesses the map 305 so as to calculate the suggested route from the starting point to the destination across the available roads (action “A4.Route”); the vector representation of this route (consisting of the coordinates of the starting point, the destination, and every intermediate junction) is stored into a corresponding table 325. For example, the route is selected so as to minimize a distance to be covered from the starting point to the destination (by applying operative research algorithms); more sophisticated techniques also take into account the different types of roads available, broadcast traffic information, and the like.

The positioning receiver driver 315 continuously supplies the coordinates of the position of the navigation system to a controller 330, so as to allow it to monitor the current location of the vehicle (action “A5.Current location”). As soon as the warning location for the next turn along the suggested route is reached, the controller 330 instructs an output driver 335 to provide the corresponding direction information to the user (action “A6.Direction information”). For example, the direction information is delivered by voice, by arrows on a graphical representation of the map, and the like.

In the solution according to an embodiment of the present invention, the navigation system also stores the descriptive information for the points of interest of the region in a corresponding repository 340, which is loaded together with the map 305 (same action “A1.Load”); preferably, for each point of interest the repository 340 stores the above-described descriptive messages with an indication of their lengths. The controller 330 further interfaces with an estimator 345; the estimator 345 accesses a log 350, which stores the measured speeds of the vehicles in the past (calculated according to the time required to cover the distance between each pair of detected positions of the navigation system). The estimator 345 calculates the timeframe required to reach the next warning location (from the current location) and returns it to the controller 330 (action “A7.Timeframe”). In this way (before reaching the warning location for the next turn) the controller 330 can select the descriptive message (from the repository 340) for the relevant point of interest (as indicated in the map 305), which length fits the available timeframe; the selected descriptive message is then provided to the output driver 335 for its delivering to the user (action “A8.Descriptive information”).

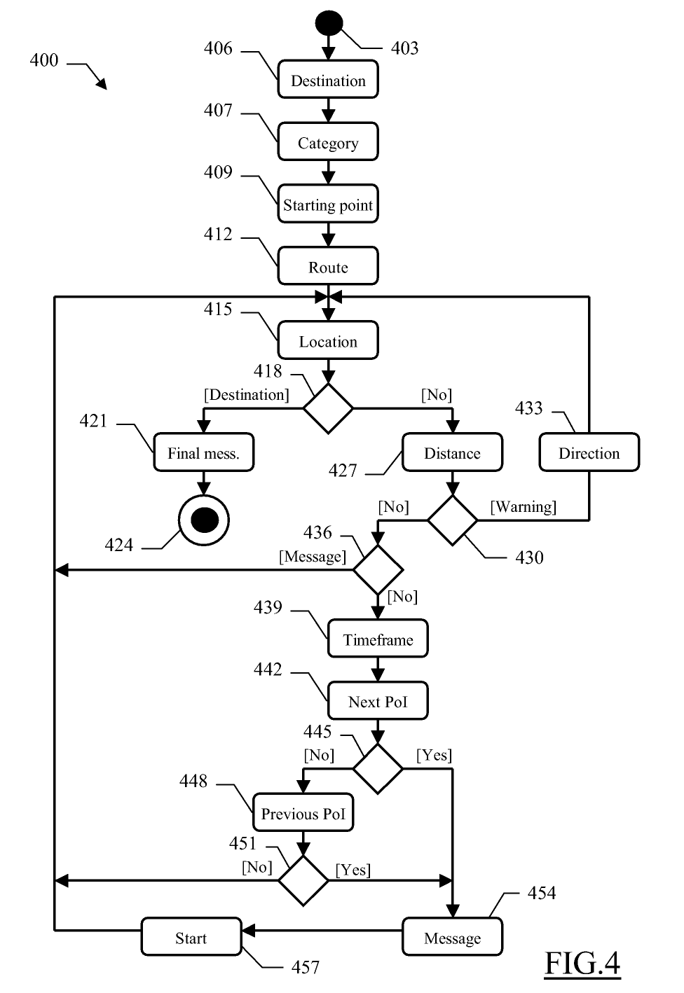

Considering now FIG. 4, the logic flow of an exemplary process that can be implemented in the above-described navigation system is represented with a method 400.

The method begins at the black start circle 403. Continuing to block 406, the user selects the desired destination. Optionally, the user at block 407 can also select one or more specific categories of the points of interest. This feature improves the usability of the provided descriptive information—by filtering out information that is not required at the moment. For example, the user may decide to receive descriptive information only about monuments while s/he is sightseeing (so as to be promptly informed of any site that might worth visiting). Another scenario relates to a user that needs to have dinner; in this case, the user decides to receive descriptive information only about restaurants; in this way, the user is advised of any encountered restaurant, so that s/he may stop to have dinner without leaving the route towards the desired destination.

The flow of activities then proceeds to block 409, wherein the starting point of the trip is determined (according to the position of the navigation system). Continuing to block 412, the navigation system calculates the suggested route (for reaching the destination from the starting point).

A loop is then performed continuously until the destination is reached (or the navigation system is switched off). The loop begins at the block 415, wherein the current location of the vehicle is detected (as defined by the position of the navigation system); in this phase, the navigation system also recalculates the suggested route when it determines that the vehicle has deviated from the previous one. A test is then made at block 418 to determine whether the vehicle is reaching the destination (for example, when its distance is below a predefined threshold, such as 500 m). If so, a final message (informing the user that s/he is approaching the destination) is output at block 421. The method then ends at the concentric white/black stop circles 424.

Conversely, block 427 is reached from block 418 when the vehicle is still far away from the destination. In this phase, the distance of the current location from the next turn along the route is calculated. A test is then made at block 430 to verify whether this distance is lower than the threshold defining the corresponding warning location. If so, the direction information for the next turn is output at block 433. The method then returns to block 415 to reiterate the same operations (until the destination is reached). In this way, the direction information always has a higher priority than the descriptive information; moreover, the outputting of any descriptive message is immediately interrupted whenever direction information must be provided to the user. As a result, the proposed solution does hot interfere in any way with the standard operation of the navigation system.

Otherwise, before reaching the warning position the flow of activities passes from block 430 to block 436, wherein the navigation system verifies whether a descriptive message is being output. If so, the method returns to block 415 without performing any operation (so as to allow completing the descriptive message). On the contrary, the available timeframe for reaching the next warning location from the current location is estimated at block 439. With reference now to block 442, the navigation system searches for the closest next point of interest following the current location along the route (before the next turn); the search is limited to the points of interest having at least one descriptive message that has not been output yet. When the user has selected one or more categories (at block 407), the navigation system takes into account the points of interest belonging to these categories only for the above-described search. If the result of the search is negative (block 445)—because no next point of interest is found or all the descriptive messages thereof have already being output—the method descends into block 448. In this phase, the navigation system likewise searches for the closest previous point of interest preceding the current location along the route, with at least one descriptive message being not output yet; as above, the search is possibly limited to the category(ies) selected by the user. If the result of the search is again negative (block 451), the method returns to block 415 without performing any action (so as to leave the navigation system mute since there is no descriptive information to be output). Conversely, block 454 is reached from block 445 (when a next point of interest has been found) or from block 451 (when a previous point of interest has been found). In both cases, the navigation system picks up the first descriptive message (for the selected point of interest), which has not being output yet—in increasing order of level of detail, from the basic one to the last advanced one. The outputting of the selected descriptive message is then started at block 457. The method again returns to block 415 to reiterate the above-described operations.

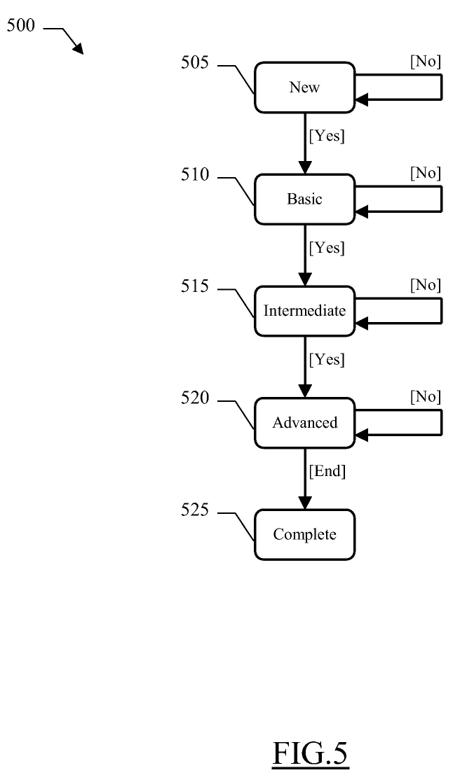

Moving now to FIG. 5, the proposed algorithm for selecting the descriptive messages to be output for each point of interest is implemented by means of a state machine 500. At the beginning, the state machine 500 is in a state 505 (“New”). Once the point of interest has been selected, the state machine 500 switches from the state 505 to a state 510 (“Basic”) if the timeframe allows, outputting the basic descriptive message (“Yes”). Moreover, the state machine 500 switches from the state 510 to a state 515 (“Intermediate”) if the timeframe allows outputting the intermediate descriptive message (“Yes”)—after outputting the basic descriptive message. Likewise, the state machine 500 switches from the state 515 to a state 520 (“Advanced”) if the timeframe again allows outputting the advanced descriptive message (“Yes”)—after outputting the basic and intermediate descriptive messages; similar considerations apply when other states (not shown in the figure) are required, for further advanced descriptive messages available for the point of interest. At the end, the state machine 500 switches from the state 520 to a state 525 (“Complete”) after all the descriptive messages have been output (“End”). In any case, the state machine 500 remains in the same state 505, 510, 515 and 520 when the timeframe does not allow outputting the corresponding descriptive message (“No”)—for their possible completion after the next points of interest.

Naturally, in order to satisfy local and specific requirements, a person skilled in the art may apply to the solution described above many modifications and alterations. Particularly, although the present invention has been described with a certain degree of particularity with reference to preferred embodiment(s) thereof, it should be understood that various omissions, substitutions and changes in the form and details as well as other embodiments are possible; moreover, it is expressly intended that specific elements and/or method steps described in connection with any disclosed embodiment of the invention may be incorporated in any other embodiment as a general matter of design choice.

Particularly, similar considerations apply if the navigation system has a different architecture or includes equivalent units. For example, any other technique may be used to input and/or output the relevant information (for example, by selecting the address of the destination through a menu with a tree organization, by providing the direction information through a video scrolling of the map, and the like); moreover, the position of the navigation system may be monitored by means of different satellite navigation systems (such as the “Galileo” system when it will be available), or even by means of any other technique (such as based on radio signals). Likewise, the map and/or the messages may be encoded in any other format (typically stored in a single memory structure), or different algorithms may be used to calculate the suggested route.

The navigation system may also be mounted on any other vehicle (such as a motorbike), or it may consist of a hand-held device. In any case, it is emphasized that the proposed solution is suitable to be applied to any data processing device with equivalent functions (such as a PDA, a mobile phone, and the like).

It should be evident that the above-mentioned descriptive information is not comprehensive; for example, it is possible to add information about opening hours of the shops or monuments, about the cost of entrance tickets, and the like. Likewise, other policies may be used to output the descriptive information. More generally this information is provided during any idle time (or part thereof) of the navigation system; for example, it is possible to output the descriptive information as a continuous stream, which is interrupted whenever the direction information must be provided.

It is also possible to estimate the available timeframe (for reaching the next warning location) with other techniques (for example, based on real-time traffic information); likewise, the descriptive information may be defined according to the timeframe in a different manner—for example, by building a single message that fits the timeframe (starting from a basic block, with the addition of as many additional blocks as possible). In any case, a very simplified implementation wherein the descriptive information is output directly without any estimation of the available timeframe is not excluded.

As above, the cited points of interest are merely illustrative; similar considerations apply to the corresponding descriptive information. However, nothing prevents outputting descriptive information that generally relates to the current location of the vehicle, independently of any specific point of interest (for example, about the whole area being crossed).

Even though in the preceding description reference has been made to specific descriptive messages for each point of interest, this is not to be intended in a limitative manner; for example, it is possible to associate any number of descriptive messages to the point of interest (even with the same, lengths).

In a different, embodiment of the invention, the navigation system at first outputs all the basic descriptive messages for all the next points of interest (before the next turn), then it returns to output their intermediate descriptive messages, and so on. Alternatively, it is also possible to have descriptive messages each one inclusive of the information of the previous ones (at lower levels of detail); in this case, for each point of interest the navigation system simply selects the longest descriptive message, that can be output (according to the available timeframe).

The feature of returning to the previous points of interest (when all the next ones have been completed) is not strictly necessary, and it may be omitted in some implementations of the proposed solution.

As above, the cited categories for the points of interest are merely illustrative; moreover, in more sophisticated embodiments the user can define more complex filtering criteria for the points of interest (for example, based on their distance from the suggested route, ort their opening, and the like). In any case, nothing prevents always taking into account all the available points of interest (without the possibility of filtering them according to the categories).

Even though in the preceding description reference has been made to a stand-alone navigation system, this is not to be intended as a limitation. Indeed, in a different embodiment of the invention the same solution is implemented by means of a service, which is deployed by a corresponding provider. More specifically, the navigation system continuously transmits its position to the service provider, which in turn returns the relevant descriptive information to be output. In this way, the service provider may supply dynamic information that is updated in real time (for example, about a waiting queue for visiting a monument).

Similar considerations apply if the program (which may be used to implement each embodiment of the invention) is structured in a different way, or if additional modules or functions are provided; likewise, the memory structures may be of other types, or may be replaced with equivalent entities (not necessarily consisting of physical storage media). Moreover, the proposed solution lends itself to be implemented with an equivalent method (by using similar steps, removing some steps being not essential, or adding further optional steps—even in a different order). In any ease, the program may take any form suitable to be used by or in connection with any data processing device, such as external or resident software, firmware, or microcode (either in object code or in source code). Moreover, it is possible to provide the program on any computer-usable medium; the medium can be any element suitable to contain, store, communicate, propagate, or transfer the program. For example, the medium may be of the electronic, magnetic, optical, electromagnetic, infrared, or semiconductor type; examples of such medium are fixed disks (where the program can be pre-loaded), removable disks, tapes, cards, wires, fibers, wireless connections, networks, broadcast waves, and the like.

In any case, the solution according to the present invention lends itself to be implemented with a hardware structure (for example, integrated in a chip of semiconductor material), or with a combination of software and hardware.

1. A method for controlling a navigation system including the steps of:
inputting an indication of a destination location,
monitoring the current location of the navigation system,
outputting direction information for reaching the destination location from the current location along a route selected on a predefined map, characterized by the step of
outputting predefined descriptive information relating to the current location during at least part of an idle time when no direction information is output.

2. The method according to claim 1, wherein the step of outputting the descriptive information includes:
estimating an available timeframe for reaching a warning location from the current location, the warning location following the current location at a threshold distance from a next turn on the map along the route, and
defining the descriptive information according to the timeframe.

3. The method according to claim 1, wherein the step of outputting the descriptive information further includes:
selecting one of a plurality of points of interest predefined in the map according to the current location, and
selecting predefined descriptive information relating to the selected point of interest.

4. The method according to claim 3 wherein a plurality of descriptive messages having corresponding lengths are predefined for each point of interest, the step of selecting the descriptive information relating to the selected point of interest including:
selecting one of the descriptive messages for the selected point of interest according to a comparison between the corresponding lengths and the timeframe.

5. The method according to claim 4, wherein the step of selecting one of the points of interest includes:
selecting the closest one of the points of interest following the current location before the next turn along the route and having at least one non-output descriptive message, and wherein the step of selecting one of the descriptive messages includes:
selecting the shortest one of the at least one non-output descriptive message for the selected point of interest.

6. The method according to claim 5, wherein the step of selecting one of the points of interest further includes, in response to the selection of no following point of interest:
selecting the closest one of the points of interest preceding the current location along the route and having at least one non-output descriptive message.

7. The method according to claim 3, wherein each point of interest belongs to one of a set of predefined categories, the method further including the step of:
selecting at least one of the categories, the selection of one of the points of interest being limited to the points of interest belonging to the at least one selected category.

8. (canceled)

9. (canceled)

10. (canceled)

11. A computer program product in a computer-usable medium including a computer program, the computer program when executed on a navigation system causing the navigation system to perform a method including the steps of:
inputting an indication of a destination location,
monitoring the current location of the navigation system,
outputting direction information for reaching the destination location from the current location along a route selected on a predefined map, and
outputting predefined descriptive information relating to the current location during at least part of an idle time when no direction information is output.

12. A navigation system including:
means for inputting an indication of a destination location,
means for monitoring the current location of the navigation system,
means for outputting direction information for reaching the destination location from the current location along a route selected on a predefined map, and
means for outputting predefined descriptive information relating to the current location during at least part of an idle time when no direction information is output.
